(19) United States
(12) Patent Application Publication
(10) Pub. No.: US 2008/0290661 A1
(43) Pub. Date: Nov. 27, 2008

(54) Adapter Tube Arrangement for Strengthening Pipe Connection

(76) Inventor: Paul W. O'Brien, Tunkhannock, PA (US)

Correspondence Address: CHARLES A. WILKINSON, ESQ., 68 EAST BROAD STREET, P. O. BOX 1426, BETHLEHEM, PA, 18016-1426, US

(21) Appl. No.: 11/936,469

(22) Filed: Nov. 7, 2007

Related U.S. Application Data
(60) Provisional application No. 60/864,743, filed on Nov. 7, 2006.

(51) Int. Cl. F16L 21/00

(52) U.S. Cl. 285/397

(57) ABSTRACT

An adapter tube for strengthening pipe connections between a supply pipe and an apparatus mounted to the supply pipe having a first outwardly tapered section, a second inwardly tapered section and a threaded female adapter wherein when the adapter is threadably secured to a supply pipe a frictional fit between the supply pipe and adapter is created. An O-ring may also be provided on the first tapered section which is modified to have a steeper angle to improve the water tightness of the device.

### CROSS REFERENCE TO RELATED APPLICATION

This application claims the benefit of U.S. Provisional Application Ser. No. 60/864,743, filed Nov. 7, 2006.

### 1. FIELD OF THE INVENTION

The present invention relates generally to pipe connections and the like, and more particularly to an adapter tube for providing a more rigid and stronger connection between two pipe sections or a pipe section and an apparatus connected to the end of a supply pipe.

### 2. BACKGROUND OF THE INVENTION

Items such as shower heads, dispensers for mixing an additive into a water supply and the like are typically secured to the end of a water supply line using a standard male and female thread connection, which connections are in general strong enough to hold the device in place without leaking or coming loose if the device is disturbed only minimally or every so often. However, increasingly such devices are being manufactured with variable settings that can only be set or changed by manually gripping the device and turning a knob or dial selector to change a setting or to activate a particular feature. For example, a typical modern shower head includes multiple spray settings, such as full body spray, jet massage, normal, and pulsating, which settings are typically selected by turning a dial selector on the face of the showerhead. In addition, separate devices for dispensing materials into the water stream, such as bath or shower salts, soap, and oils, are becoming increasingly popular. Such devices often require a permanent connection interposed between the shower pipe or water supply line and the conventional shower head. While such devices are fairly desirable, they add to the overall weight attached to the water supply line, and in addition usually require activation by turning or rotating a knob or the like on the device as well.

As a result, there is an increased amount of stress placed on the standard threaded male-female connections between the water supply line and such devices, with the unfortunate result being that the connections more quickly and often become loosened due to such increased stress, causing leaks, or they may break altogether, potentially requiring an expensive repair or even causing major damage due to flooding caused by a break. Thus, there is a need for an arrangement that results in a stronger, rigid and more durable connection between a water supply line and a device such as a shower head or dispenser placed on the end of such supply line, which device does not substantially affect the water flow or pressure passing through the line.

### OBJECTS OF THE INVENTION

It is a primary object of the present invention to provide a means for creating a stronger and more rigid and durable connection between a pipe line and a device connected to the end of said pipe line.

It is a further object of the invention to provide an adapter tube one end of which is fitted into the end of a water supply line and the other end of which is permanently secured to a device to be connected to the end of said water supply line, increasing the surface area of the connection and creating a more rigid, more durable, and stronger connection between the line and device.

Still other objects and advantages of the invention will become clear upon review of the following detailed description in conjunction with the appended drawings.

### SUMMARY OF THE INVENTION

Disclosed is an adapter arrangement for creating sturdier pipe connections comprising an adapter tube having an upper end, a lower end, and an aperture extending longitudinally through the length of said valve. The adapter tube has a first outer surface section which is outwardly tapered extending from the upper end of the tube to a ledge, with the diameter of such outer surface section directly adjacent the ledge being just slightly less than the inner diameter of the supply pipe in which such section is to be secured. A second inwardly tapered outer surface section extends rearwardly from the ledge to approximately the midpoint of the tube, and a third outer surface section adjacent said second outer surface section is used to join the tube permanently to a device to be secured to the pipe line. Also included is a female adapter having an interior aperture, a section of which is dimensioned and tapered to correspond with the second inwardly tapered outer surface section of the adapter tube such that the female adapter is prevented from being removed from the tube, and having female threads arranged to receive male threads on the end of the supply pipe, whereby when the female adapter is secured to the supply pipe via the threads, the matching tapered sections of the female adapter and adapter tube are pressed together to create a frictional fit and sturdier connection between the supply pipe and device. An O-ring may also be provided on the outer surface of the first tapered section to provide an even more water tight fit so that the tube can be used with pipe of slightly different sizes without requiring teflon tape to be wrapped around the threads.

### BRIEF DESCRIPTION OF THE DRAWINGS

FIG. 1 is a perspective view of the adapter tube of the present invention.

FIG. 2 is an exploded view of a dispenser device to be secured to the end of a water supply line illustrating the adapter tube of the present invention.

FIG. 3 is a cross-sectional view showing the adapter tube being used to connect a dispenser device to a water supply line.

FIG. 4 illustrates an alternative embodiment of the invention having an O-ring on the pipe engaging end of the adapter tube.

### DESCRIPTION OF THE PREFERRED EMBODIMENTS

The following detailed description is of the best mode or modes of the invention presently contemplated. Such description is not intended to be understood in a limiting sense, but to be an example of the invention presented solely for illustration thereof, and by reference to which in connection with the following description and the accompanying drawings one skilled in the art may be advised of the advantages and construction of the invention. The invention is intended to cover alternatives, modifications, and equivalents, which may be included within the spirit and scope of the invention as defined by the appended claims.

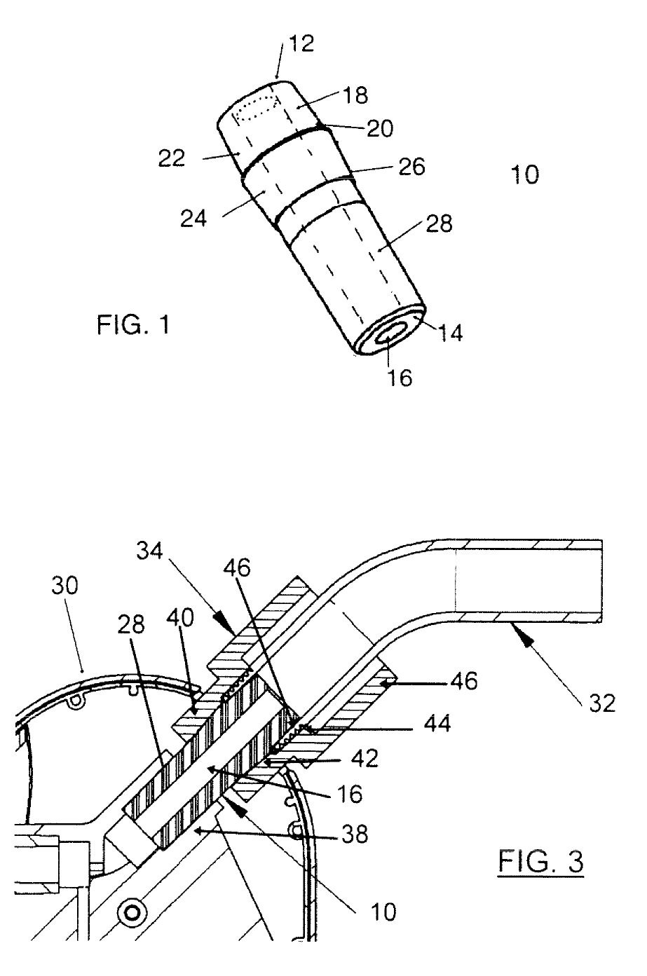

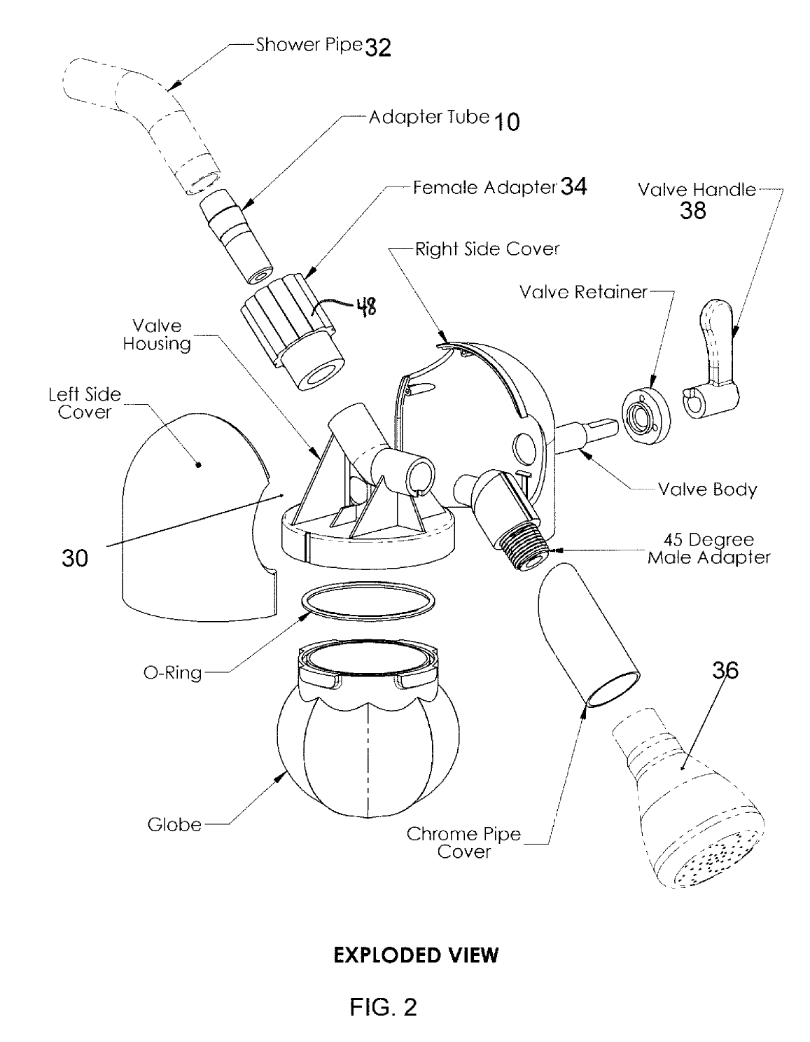

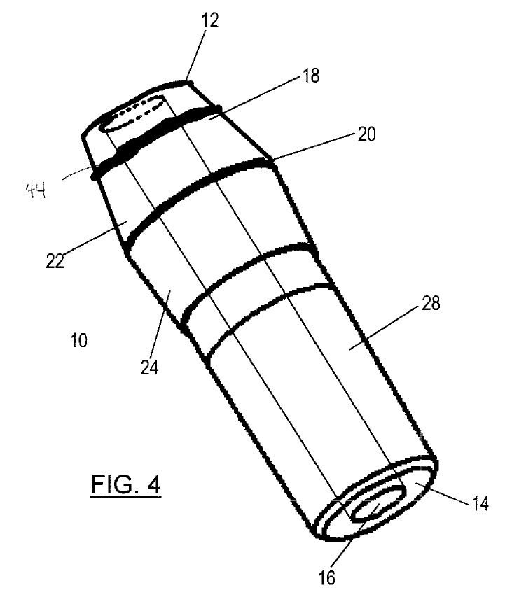

FIG. 1 illustrates the adapter tube 10 of the present invention. Adapter tube 10 is preferably molded from a single piece of plastic material, but could be made from any other suitable material, such as metal. Adapter tube 10 generally has a tubular shape with a rounded outer surface, and includes an upper end 12, a lower end 14, and a bore 16, shown in dotted lines, extending longitudinally through its entire length. As shown generally in FIG. 2, upper end 12 is sized so as to fit snugly in the end of a water supply pipe, while lower end 14 is secured preferably permanently to a device to be connected to the water supply pipe, such as the dispenser shown in FIGS. 2 and 3.

More particularly, adjacent upper end 12 of adapter tube 10 is a section 18 the outer surface of which tapers outwardly slightly from upper end 12 to ledge 20. The diameter 22 of section 18 adjacent ledge 20 is just slightly less than the internal diameter of the supply pipe in which such section of the adapter tube is to be inserted, so that section 18 fits snugly in the supply pipe with the front edge of the pipe opening pressing against ledge 20. In addition, the diameter of tube 10 at ledge 20 should be slightly less than the external diameter of the supply pipe, so that the tube does not interfere with the attachment of the male threads of the supply pipe connector to a female threaded adapter. Of course, the exact dimensions of section 18 of tube 10 may be varied and are dependent upon the dimensions such as the inner and outer diameter of the supply pipe to which the adapter tube 10 is to be fitted.

Extending rearwardly from ledge 24 to point 26 is a gradually inwardly tapered section 24. In addition, extending rearwardly from point 26 is section 28 of adapter tube 10, the outer diameter of which section is generally constant to rear end 14. The inner diameter 16 of adapter tube 10 will preferably be consistent as much as possible in most cases with the inner diameter of the valve or the like to which the adapter tube is connected, which of course will also be dependent and variable upon the exact nature of the device being connected to the supply line.

FIG. 2 is an exploded view of a dispenser device 30 which is to be attached to the end of a water pipe or supply line 32 by a female adapter 34 secured to the dispenser device, and further utilizing adapter tube 10 to create a stronger, more rigid and stable connection between device 30 and pipe 32. In general, device 30, which as illustrated is a device for dispensing an additive material such as baths salts or oils into a water supply line, is to be connected permanently or for long term use between shower pipe 32 and showerhead 36. Since device 30 must be turned on and off by rotating handle 38, such repeated turning places additional stress on the connection between shower pipe 32 and female adapter 34, which connection as a result eventually will become loose or even break. Adapter tube 10 thus acts as a reinforcing member for such connection.

FIG. 3 is a cross-sectional view showing adapter tube 10 in use with respect to the connection between shower pipe 32 and female adapter 34 for connecting dispenser device 30. First, the outer surface of section 28 of adapter tube 10 is permanently secured, preferably by gluing, to the inner surface 36 of valve 38 of dispenser device 30. If desired, a section of the walls of valve 38 may be cut away so that section 28 fits snugly in valve 38 with the inner diameter 16 being consistent with or equal to the inner diameter of valve 38. Alternatively, the adapter may be integrally molded on the end of such valve or line. At the same time, the narrow end 40 of female adapter 34, which narrow end has an internal taper 42 corresponding to the taper of the outer surface of section 24 of adapter 10, is fitted around section 24 of adapter tube 10 (see FIG. 1), thereby permanently securing female adapter 34 to dispenser device 30 via adapter tube 10.

Situated adjacent internal taper 42 of female adapter 34 is female threaded section 44, which threads are dimensioned to threadably receive male threads 46 on the free end of water supply line 32. Thus, to connect water supply line 32 to dispenser device 30, female adapter 34 is brought into close proximity with supply line 32 so that front section 18 of adapter tube 10 is placed inside supply line 32. Then as male threads 46 of supply line 32 are interlocked with female threads 44 of female adapter 34, female adapter 34 is caused to move upwardly towards supply line 32 until the inner surface of tapered section 42 of female adapter 34 is wedged tightly and pressing outwardly against the outer surface of tapered section 24 of adapter tube 10, creating a surprisingly strong frictional fit. Such arrangement thus not only provides the usual rigid connection of female threads 44 of female adapter 34 with male threads 46 of water supply line 34, but also adds the further rigid connection between external tapered surface 24 of adapter tube 10 with the inner tapered surface 42 of smaller section 40 of female adapter 34. A wider extension section 46 of female adapter 34 may also be provided, with the outer surface 48 of such extension, as shown in FIG. 2, having a patterned surface which may be easily gripped by a wrench or the like to facilitate tightening of the adapter to water supply pipe or line 32.

FIG. 4 illustrates an alternative embodiment of the invention wherein section 18 of the adapter adjacent upper end 12 is provided having more of a cone shape or a steeper angle. In addition, an O-ring 44 will be provided approximately one eighth of an inch from upper end 12, preferably situated in a groove at such position on the outer surface of the device. It has been found that since there are numerous slightly different sized pipes, previously in order to ensure a water tight fitting several layers or more of teflon tape would be wrapped around the threads and fitting. However, with the addition of O-ring 44, such tape is no longer necessary as the O-ring provides a water tight fit with the threads when tightened.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention.

I claim:

1. An adapter arrangement for creating sturdier pipe connections comprising:
an adapter tube, said tube having an upper end, a lower end, and an aperture extending longitudinally through the length of said valve,
said tube having a first outer surface section which is outwardly tapered extending from the upper end of the tube to a ledge, the diameter of said outer surface section directly adjacent the ledge being just slightly less than the inner diameter of the supply pipe in which said section is secured,
a second inwardly tapered outer surface section extending rearwardly from said ledge to approximately the midpoint of the tube,
a third outer surface section adjacent said second outer surface section, which third section is permanently secured to a device to be secured to a pipe line,
a female adapter having an interior aperture, a section of which is dimensioned and tapered to correspond with said second inwardly tapered outer surface section of the adapter tube such that the female adapter is prevented from being removed from said tube,
said female adapter having female threads arranged to receive male threads on the end of said supply pipe,
whereby when the female adapter is secured to the supply pipe via the threads, the matching tapered sections of the female adapter and adapter tube are pressed together creating a frictional fit and sturdier connection between the supply pipe and device.

2. The adapter tube of claim 1 additionally comprising a O-ring provided on the outer surface of said first outer surface section.
